(19) United States
(12) Patent Application Publication
(10) Pub. No.: US 2022/0064768 A1
(43) Pub. Date: Mar. 3, 2022

(54) STEEL RESISTANT TO SEAWATER CORROSION AND MANUFACTURING METHOD THEREFOR

(71) Applicant: BAOSHAN IRON & STEEL CO., LTD., Shanghai (CN)

(72) Inventors: Donghui WEN, Shanghai (CN); Fengming SONG, Shanghai (CN); Ana YANG, Shanghai (CN); Wei WANG, Shanghai (CN); Zigang LI, Shanghai (CN); Qingjun ZHOU, Shanghai (CN); Lede MIAO, Shanghai (CN)

(73) Assignee: BAOSHAN IRON & STEEL CO., LTD., Shanghai (CN)

(21) Appl. No.: 17/417,259

(22) PCT Filed: Dec. 24, 2019
(86) PCT No.: PCT/CN2019/128004

§ 371 Date: Jun. 22, 2021

(30) Foreign Application Priority Data
Dec. 24, 2018 (CN) 201811580228.7

(51) Int. Cl. C22C 38/50; C22C 38/42; C22C 38/44; C22C 38/00; C22C 38/02; C22C 38/04; C22C 38/06; C21D 8/02; C22C 33/04; C22C 33/08

(52) U.S. Cl. CPC C22C 38/50; C22C 38/42; C22C 38/44; C22C 38/002; C22C 38/02; C22C 38/04; C21D 2211/005; C21D 8/0205; C21D 8/0226; C21D 8/0263; C22C 33/04; C22C 33/08; C21D 2211/002; C22C 38/06

(57) ABSTRACT

The present invention discloses a seawater-corrosion-resistant steel, the mass percentage of the chemical elements thereof being: 0.03-0.05% of C, 0.04-0.08% of Si, 0.8-1.2% of Mn, 0.1-0.2% of Cu, 2.5-5.5% of Cr, 0.05-0.15% of Ni, 0.15-0.35% of Mo, 1.5-3.5% of Al, 0.01-0.02% of Ti, 0.0015-0.003% of Ca, and the balance being Fe and other inevitable impurities. The present invention further discloses a method for manufacturing the seawater-corrosion-resistant steel. The method includes the following steps: (1) smelting and casting; (2) reheating: reheating a casting blank to 1200° C.-1260° C.; (3) rough rolling; (4) finish rolling; (5) coiling; and (6) cooling to room temperature. The seawater-corrosion-resistant steel has good seawater corrosion resistance and excellent mechanical properties.

### TECHNICAL FIELD

The present invention relates to a steel and a manufacturing method therefor, and in particular to a corrosion-resistant steel and a manufacturing method therefor.

### BACKGROUND OF THE INVENTION

The corrosion resistance of a corrosion-resistant steel is improved by selectively adding appropriate alloy elements such as Cu, P, Cr, Ni, Mo, Al, Ca, Mg and Sb on the basis of a plain carbon steel. The corrosion-resistant steel may be divided into a atmospheric-corrosion-resistant steel, a seawater-corrosion-resistant steel, an acid-resistant steel and the like according to the service environments, wherein the atmospheric-corrosion-resistant steel is also referred to as a weathering steel. The corrosion-resistant steel is capable of effectively prolonging the service life of a steel structure so as to reduce the use cost and the burden for the environment, thereby being widely applied to various fields.

However, in the prior art, the corrosion-resistant steel is mainly centralized in the aspect of atmospheric corrosion resistance, and there are few seawater-corrosion-resistant steels. In addition, an existing seawater-corrosion-resistant steel also has certain defects. For example, the existing seawater-corrosion-resistant steel is not high in strength so as to be incapable of meeting production requirements on high strength and weight reduction. For another example, more alloys such as Ni, P and S are added in a component system of the seawater-corrosion-resistant steel, so that the seawater-corrosion-resistant steel is relatively high in manufacturing cost and poor in plasticity, toughness and welding property.

A Chinese patent document with the publication No. CN101029372 and the title “Seawater-Corrosion-Resistant Steel” published on Sep. 5, 2007 discloses a seawater-corrosion-resistant steel and a production method therefor. In the technical solution disclosed in the patent document, due to the cooperation of Cu—Cr—Mo in the component system of the seawater-corrosion-resistant steel, a certain seawater corrosion resistance is achieved, but the yield strength of the seawater-corrosion-resistant steel is no more than 450 MPa, and therefore, the current design requirements on high strength and weight reduction are difficult to meet.

A Chinese patent document with the publication No. CN105154789A and the title “High-Property Water Riser Steel For Deep Sea And Production Method” published on Dec. 16, 2015 discloses a high-property water riser steel for deep sea. In the technical solution disclosed in the patent document, a component system of the high-property water riser steel for deep sea belongs to a Cu—Ni—Cr—Mo system, wherein the high-property water riser steel for deep sea contains 0.7-1.5% of Ni so as to be relatively high in cost.

A Chinese patent document with the publication No. CN105256233A and the title “Corrosion-Resistant Steel For Marine Application” published on Jan. 20, 2016 discloses a corrosion-resistant steel for marine application. In the technical solution disclosed in the patent document, due to the cooperation of Cr—Al, the seawater corrosion resistance is achieved. However, the highest yield strength in the technical solution only reaches 390 MPa.

Based on this, a seawater-corrosion-resistant steel is expected to be achieved and is mainly applied to a steel structural member such as a steel sheet pile in a marine environment, and the seawater-corrosion-resistant steel has high strength and excellent corrosion resistance.

### SUMMARY OF THE INVENTION

One of objectives of the present invention is to provide a seawater-corrosion-resistant steel. The seawater-corrosion-resistant steel not only has good seawater corrosion resistance, but also has high strength and excellent toughness and welding property so as to be very beneficial to meeting requirements on high strength and weight reduction of a marine steel structure.

In order to achieve the above-mentioned objective, the present invention provides a seawater-corrosion-resistant steel, the mass percentage of the chemical elements thereof is:

0.03-0.05% of C, 0.04-0.08% of Si, 0.8-1.2% of Mn, 0.1-0.2% of Cu, 2.5-5.5% of Cr, 0.05-0.15% of Ni, 0.15-0.35% of Mo, 1.5-3.5% of Al, 0.01-0.02% of Ti, 0.0015-0.003% of Ca, and the balance being Fe and other inevitable impurities.

In the seawater-corrosion-resistant steel provided by the present invention, all the chemical elements are designed according to a principle described as follows:

C: in the seawater-corrosion-resistant steel provided by the present invention, C may be integrated into a steel matrix, thereby achieving a solid solution strengthening effect. In addition, C is capable of forming fine carbide precipitation particles to further achieve a precipitation strengthening effect. Therefore, in order to guarantee an implementation effect, the mass percentage of C in the steel related to the present invention is not lower than 0.03. However, on the other hand, C of which the content exceeds an upper limit of a range value of the present invention may be unfavorable to the welding property, toughness and plasticity of the steel plate. In addition, the inventor of the present invention further considers that the mass percentage of C may affect the formation of pearlite structures and other carbides. In order to ensure that a microstructure of the related steel is a homogeneous-phase structure and avoid primary battery corrosion caused by a potential difference between different phases to improve the corrosion resistance of the steel related to the present invention, the mass percentage of C in the seawater-corrosion-resistant steel provided by the present invention is controlled at 0.03-0.05%.

Si: in the technical solution of the present invention, Si is a deoxidizing element so as not to form a carbide. In addition, Si replaces Fe atoms in a replacement mode in the steel related to the present invention to impede dislocation movement, thereby realizing solid solution strengthening. In addition, found by the inventor of the present invention, Si has relatively high solid solubility in steel and is capable of increasing the volume fraction of a ferrite in the steel and refining crystal grains, and therefore, the addition of Si is remarkably beneficial to the improvement on the toughness of the steel related to the present invention. However, the strength improving effect of Si is lower than that of C, and the addition of Si may increase the hardening rate during cold machining and lower the toughness and plasticity of the steel related to the present invention to a certain extent. In addition, the inventor of the present invention considers that excessive Si is capable of accelerating graphitization of C, unfavorable to the toughness and also unfavorable to surface quality and welding property. Based on the above-mentioned consideration, the inventor of the present invention controls the mass percentage of Si in the seawater-corrosion-resistant steel provided by the present invention at 0.04-0.08%.

Mn: for the seawater-corrosion-resistant steel provided by the present invention, Mn is a strengthening element in steel and is also an essential element for deoxidization during steelmaking. In addition, in the technical solution of the present invention, Mn is capable of accelerating transformation of medium-low-temperature structures, refining a microstructure of the seawater-corrosion-resistant steel provided by the present invention and also playing a role in inhibiting the formation of a meshy cementite, thereby being relatively beneficial to the improvement on the toughness of the steel related to the present invention. However, on the other hand, when the mass percentage of Mn exceeds an upper limit defined by the present invention, it is easy to result in segregation, furthermore, a matrix structure is deteriorated, and greater MnS is mixed, thereby deteriorating the weldability and the toughness in a welding heat affected zone of a steel plate made of the steel related to the present invention. In addition, excessive Mn may also reduce the heat conducting coefficient of the steel related to the present invention, reduce the cooling speed and generate coarse crystal so as to be very unfavorable to the toughness and fatigue property of the steel. Therefore, in the seawater-corrosion-resistant steel provided by the present invention, the mass percentage of Mn is controlled at 0.8-1.2%.

Cu: in the technical solution of the present invention, Cu has a solid solution strengthening effect. In addition, in the seawater-corrosion-resistant steel provided by the present invention, when the mass percentage of Cu exceeds a lower limit value defined by the present invention, Cu can be tempered at an appropriate temperature to achieve a secondary hardening effect, thereby improving the strength of the steel related to the present invention. Meanwhile, Cu is also one of elements capable of improving the corrosion resistance, the electrochemical potential of Cu is higher than Fe, and therefore, it is beneficial to the acceleration of the densification of a rust layer on the surface of the steel and the formation of a stable rust layer. In addition, found by the inventor of the present invention, the atmospheric corrosion resistance of the steel related to the present invention can be remarkably improved when Cu and Ni are appropriately proportioned. However, on the other hand, when the mass percentage of Cu exceeds an upper limit defined by the present invention, it is possible to affect the welding property, and mesh cracks are easy to occur during hot rolling. Therefore, in the seawater-corrosion-resistant steel provided by the present invention, the mass percentage of Cu is controlled at 0.1-0.2%.

Cr: for the seawater-corrosion-resistant steel provided by the present invention, Cr is a corrosion-resistant element of the steel related to the present invention and has a remarkable effect of improving the passivation capability of the steel. In addition, Cr is also capable of accelerating the formation of a dense passivation film or protective rust layer on the surface of the steel and is enriched in the rust layer so as to be capable of effectively improving the property that a corrosive medium selectively penetrates through the rust layer. In addition, found by the inventor of the present invention, due to the addition of Cr, the self-corrosion potential of the steel can be effectively improved, and corrosion can be inhibited. In addition, Cr is capable of forming a continuous solid solution with Fe in the steel related to the present invention so as to achieve a solid solution strengthening effect, and forming various types of carbides such as M3C, M7C3 and M23C6 with C so as to further achieve a secondary strengthening effect. However, found by the inventor of the present invention, Cr has a “reverse” effect in terms of improvement on the seawater corrosion resistance of the steel related to the present invention, which is mainly caused by pitting corrosion. Therefore, the inventor of the present invention adds an appropriate amount of Mo, thereby inhibiting the “reverse” effect of Cr. However, Cr of which the content exceeds an upper limit defined by the present invention not only increases the manufacturing cost of the steel plate, but also is unfavorable to welding property and toughness. Based on this, in the steel resistant to seawater corrosion provided by the present invention, the mass percentage of Cr is controlled at 2.5-5.5%, and preferably, the mass percentage of Cr may be further controlled at 3.0-4.5%.

Ni: in the technical solution of the present invention, Ni is an important element for improving the corrosion resistance of steel and is capable of promoting the stability of the rust layer. In addition, the Ni is also capable of relieving the problem of hot machining brittleness caused by Cu. Moreover, the Ni is capable of improving the toughness and hardenability and effectively stopping the mesh cracks caused by hot brittleness of Cu while improving the strength of the steel related to the present invention. However, since Ni is a precious metal element, the addition of excessive Ni is not beneficial to the reduction of the manufacturing cost, and excessive Ni may improve the adhesion of scale and may form a hot rolling defect on the surface if it is pressed into the steel. Therefore, in the seawater-corrosion-resistant steel provided by the present invention, the mass percentage of Ni is controlled at 0.05-0.15%.

Mo: in the seawater-corrosion-resistant steel provided by the present invention, Mo exists in the steel in a carbide and solid solution mode, thereby improving the hardenability of the steel related to the present invention, inhibiting the formation of a polygonal ferrite and pearlite and playing a role in accelerating the formation of a martensite structure. In addition, in the technical solution of the present invention, Mo is also capable of achieving phase transformation strengthening and dislocation strengthening effects. Furthermore, when Mo coexists with Cr and Mn, the temper brittleness caused by other elements can be lowered, and the low-temperature impact toughness of the steel plate can be improved. Moreover, due to the addition of Mo in the seawater-corrosion-resistant steel provided by the present invention, a gap formed by pitting corrosion of Cl⁻ (chloride ions) on steel can be automatically supplemented in a seawater corrosion environment to form a dense protective layer for stopping pitting corrosion from developing in depth, and therefore, the corrosion resistance can be further improved by adding Mo in corrosion-resistant steel containing Cr. Therefore, Mo is added into the steel related to the present invention. However, on the other hand, Mo with a relatively high mass percentage may be unfavorable to the welding property and result in relatively high manufacturing cost. Based on the above-mentioned comprehensive consideration, in the seawater-corrosion-resistant steel provided by the present invention, the mass percentage of Mo is controlled at 0.15-0.35%.

Al: in the technical solution of the present invention, Al is an element for forming the ferrite and is added as a deoxidizing agent in steel during steelmaking, and a trace amount of Al forms fine AlN to be precipitated during steelmaking, achieves an effect of refining crystal grains of an austenite in the subsequent cooling process and improves the toughness of the steel. In addition, in the steel related to the present invention, Al is also used as a fixing agent for N, and Al has good oxidation resistance and is capable of generating a corrosion-resistant oxide layer on the surface after being exposed to the air, and therefore, the atmospheric corrosion resistance of the steel can be improved by appropriately adding Al. Moreover, after Al is added, the corrosion potential of the steel is improved, meanwhile, Al and O (oxygen) can form a dense Al₂O₃ film on a surface layer, and the film contains substances α-Al₂O₃, AlFeO₃ and AlFe₃ with good corrosion resistance, thereby being beneficial to the improvement on the corrosion resistance. Particularly, in the seawater-corrosion-resistant steel provided by the present invention, due to the cooperated addition of Al and Cr, the corrosion resistance of the steel related to the present invention can be remarkably improved. However, Al of which the content exceeds an upper limit value defined by the present invention may increase the brittleness of the ferrite in the steel to further lower the toughness of the steel. Therefore, in the technical solution of the present invention, the mass percentage of Al is controlled at 1.5-3.5%. Preferably, the mass percentage of Al can be further controlled at 1.5-2.2%. In addition, cooperated addition of Al and Cr is taken into consideration, and therefore, in some preferred embodiments, the mass percentage of Al and Cr can be controlled to meet the conditions: the ratio of Cr/Al is 0.8-4, and Cr+Al≤7.0%. In this way, on one hand, the alloy cost is controlled, meanwhile, the cooperation effect of Al and Cr in terms of corrosion resistance is better exerted, and it is ensured that the steel has excellent corrosion resistance in the marine environment.

Ti: in the technical solution of the present invention, Ti is a powerful ferrite forming element and carbonitride forming element a compound of Ti is high in melting point, and Ti has an effect of impeding the growth of an austenite during heating. In addition, found by the inventor of the present invention, the precipitated carbonitride is capable of pinning a crystal boundary, thereby refining crystal grains of the austenite, stopping crystal grains in the welding heat affected zone from growing and being beneficial to the improvement on the welding property of the steel plate made of the steel related to the present invention. Therefore, in the seawater-corrosion-resistant steel provided by the present invention, the mass percentage of Ti is controlled at 0.01-0.02%. On one hand, the growth of the crystal grains of the austenite in a plate blank reheating process can be inhibited, meanwhile, the growth of crystal grains of the ferrite can be inhibited during controlled rolling of recrystallization, and the toughness of the steel is improved. Moreover, on the other hand, the corrosion rate can be obviously reduced by adding a trace amount of Ti into the Al-containing steel related to the present invention. In addition, in the technical solution of the present invention, Ti can be preferably bonded with N in the steel, so that the amount of AlN in the steel is reduced. However, if the mass percentage of Ti exceeds an upper limit defined by the present invention, titanium nitride particles are easy to grow and agglomerate at high temperature, and furthermore, the plasticity and toughness of the steel related to the present invention are damaged.

Ca: in the technical solution of the present invention, due to the addition of Ca into the steel related to the present invention, the shape of a sulfide can be changed, the hot brittleness of S can be inhibited, and the toughness can be improved. In addition, Ca added into the steel exists in a state of compounds (CaS, CaO or other compounds) and can generate a microcell weak-alkaline environment by a hydrolysis reaction so as to be beneficial to the formation of a protective oxide α-FeOOH. Moreover, on the other hand, micro-Ca treatment can improve the form and distribution of inclusions and is beneficial to the improvement on the isotropy of toughness and mechanical properties. In order to guarantee an implementation effect, the mass percentage of Ca should not be lower than a lower limit value defined by the present invention. However, once the mass percentage of Ca exceeds an upper limit value defined by the present invention, it is easy to lower the purity of the steel and deteriorate the toughness of the welding heat affected zone. Therefore, in the seawater-corrosion-resistant steel provided by the present invention, the mass percentage of Ca is controlled at 0.0015-0.003%, and in some embodiments, the mass percentage of Ca can further meet the condition: Ca/S≥0.65, thereby ensuring that there are sufficient Ca to be bonded with S, and avoiding the phenomenon that redundant S remains in the steel to generate adverse effects on the plasticity, toughness and the like.

In conclusion, it can be seen that in the technical solution of the present invention, relatively cheap Cr and Al are adopted as main corrosion-resistant elements and are appropriately proportioned to improve the seawater corrosion resistance, and Mo is added to improve the property of inhibiting pitting corrosion. In addition, further found by the inventor of the present invention, a precipitate of Ti is beneficial to the precipitation strengthening of a matrix, while Ca treatment is beneficial to the improvement on the toughness and welding property of the matrix. Therefore, the inventor of the present invention designs component ranges of the above-mentioned elements to ensure that the seawater-corrosion-resistant steel provided by the present invention has a matrix structure including a bainite and a ferrite, so that the steel not only has good seawater corrosion resistance, but also has high strength and excellent toughness and welding property, which is beneficial to the high strength and weight reduction of a marine steel structure.

Further, in the seawater-corrosion-resistant steel provided by the present invention, the mass percentage of the elements Cr and Al further meets the following: the ratio of Cr/Al is 0.8-4, and Cr+Al≤7.0%.

Further, in the seawater-corrosion-resistant steel provided by the present invention, the mass percentage of Cr is 3.0-4.5%, and/or the mass percentage of Al is 1.5-2.2%.

Further, in the seawater-corrosion-resistant steel provided by the present invention, in other inevitable impurities, elements P, S and N satisfy at least one of mass percentage as follows: P≤0.015%, S≤0.004%, and N≤0.005%.

S is easy to form a plastic inclusion manganese sulfide with Mn during solidification so as to be unfavorable to the plasticity and the toughness. Meanwhile, S is easy to oxidize during welding to form an SO₂ gas, resulting in defects including weld pores and looseness. Moreover, S is also a main element for generating hot brittleness during hot rolling. Therefore, in the technical solution of the present invention, the lower mass percentage of S is better. However, the cost factor needs to be taken into consideration, and therefore, in the seawater-corrosion-resistant steel provided by the present invention, the mass percentage of S is controlled at S≤0.004%.

P is capable of accelerating the formation of the protective rust layer on the surface of the steel related to the present invention and effectively improving the atmospheric corrosion resistance, but P is liable to segregate on the crystal boundary to lower the bonding energy of the crystal boundary as well as the toughness and plasticity of the steel. In addition, P coexists with Mn, which will increase the temper brittleness of the steel, segregated P enables the steel plate to be liable to generate intergranular fracture, and therefore, the impact toughness of the seawater-corrosion-resistant steel provided by the present invention is lowered. Moreover, P is unfavorable to the welding property, and therefore, in the technical solution of the present invention, P is a harmful element, that is, an impurity, and the mass percentage of P needs to be controlled at P≤0.015%. In addition, the mass percentage of N serving as a harmful element also needs to be controlled at N≤0.005%.

Further, in the seawater-corrosion-resistant steel provided by the present invention, the mass percentages of Ca and S further satisfied: Ca/S≥0.65.

Further, the seawater-corrosion-resistant steel provided by the present invention has a microstructure of bainite and ferrite.

It should be noted that Cr, Al, Ca and S in the above-mentioned formula respective represent their mass percentage, and values substituted into the above-mentioned formula are values in front of percentage signs. For example, the mass percentage of Ca is 0.0022%, the mass percentage of S is 0.0032%, and then, they are substituted into the above-mentioned formula to obtain Ca/S=0.0022/0.0032=0.69.

Further, the seawater-corrosion-resistant steel provided by the present invention has the yield strength of 450 MPa or above, the tensile strength of 550 Mpa or above, and an annual average corrosion rate of no more than 0.1 mm/a when fully immersed in seawater.

Accordingly, another objective of the present invention is to provide a method for manufacturing the above-mentioned seawater-corrosion-resistant steel. The seawater-corrosion-resistant steel, obtained by using the method, not only has good seawater corrosion resistance, but also has high strength and good toughness and welding property so as to be very suitable for a marine steel structure.

In order to achieve the above-mentioned objective, the present invention provides a method for manufacturing the above-mentioned seawater-corrosion-resistant steel. comprising steps of:

(1) smelting and casting;

(2) reheating: wherein a casting blank is reheated to 1200° C.-1260° C.;

(3) rough rolling;

(4) finish rolling;

(5) coiling; and

(6) cooling to room temperature.

It should be particularly indicated that, in the manufacturing method provided by the present invention, in step (2), the casting blank is controlled to be reheated at 1200° C.-1260° C., this is because the seawater-corrosion-resistant steel, obtained by using the method provided by the present invention, contains more alloy elements such as Cr and Mo, the adoption of a higher heating temperature is beneficial to the sufficient solid solution and uniformization of the alloy elements and is further beneficial to the improvement on the material uniformity of the casting blank and subsequent improvement on properties of the steel plate, and therefore, the inventor of the present invention controls the reheating temperature of the casting blank within the range of 1200° C.-1260° C.

Further, in the manufacturing method provided by the present invention, in step (3), an ending temperature of step of rough rolling is controlled at 950° C.-1150° C. In some embodiments, when the thickness of a steel plate does not exceed 12 mm, the accumulative deformation in step of rough rolling is controlled to be 80% or above. In some embodiments, when the thickness of the steel plate exceeds 12 mm, the accumulative deformation in step of rough rolling can be controlled to be 70% or above.

Further, in the manufacturing method provided by the present invention, in step (4), an ending temperature of step of finish rolling is controlled to be not lower than 800° C. In addition, in some embodiments, when the thickness of the steel plate does not exceed 12 mm, a deformation ratio in step of finish rolling is controlled to be 5 or above. In some embodiments, when the thickness of the steel plate exceeds 12 mm, the deformation ratio in step of finish rolling may be controlled to be 3.5 or above.

Further, in the manufacturing method provided by the present invention, in step (5), the finish-rolled steel plate is water-cooled to 550-650° C. for coiling.

Compared with the prior art, the seawater-corrosion-resistant steel and the manufacturing method therefor provided by the present invention have the following advantages and beneficial effects: the seawater-corrosion-resistant steel provided by the present invention not only has good seawater corrosion resistance, but also has high strength and good toughness and welding property so as to be very suitable for a marine steel structure.

In addition, the seawater-corrosion-resistant steel provided by the present invention adopts the design of a Cr—Al—Mo component system. Due to the cooperated addition of the alloy elements Cr and Al, the seawater corrosion resistance is improved. Due to the addition of Mo, pitting corrosion is inhibited, a “reverse” effect of Cr with a relatively high content in inhibiting corrosion under a seawater environment is eliminated, and therefore, the seawater corrosion resistance is further improved.

In addition, the seawater-corrosion-resistant steel provided by the present invention is good in forming property, capable of meeting the subsequent cold machining requirement of the steel plate, easy to weld and capable of meeting a requirement on welding without preheating at a temperature higher than 0° C.

The manufacturing method provided by the present invention also has the above-mentioned advantages and beneficial effects. In addition, a controlled rolling and cooling production process is adopted in the manufacturing method provided by the present invention. In this way, heat treatment is not needed after rolling, and the steel can be supplied directly in a hot rolling state, thereby effectively shortening the supply period and reducing the production cost.

### BRIEF DESCRIPTION OF THE DRAWING

FIG. 1 shows a microstructure of a seawater-corrosion-resistant steel in embodiment 1.

### DETAILED DESCRIPTION OF THE INVENTION

A seawater-corrosion-resistant steel and a manufacturing method therefor provided by the present invention will be further explained and described below in conjunction with the specific embodiments and the accompanying drawings of the specification. However, the explanation and description do not construct improper limitations to the technical solutions of the present invention.

### Embodiments 1-6

The mass percentage (mass %) of each of chemical elements in seawater-corrosion-resistant steel in the embodiments 1-6 is listed in table 1.

TABLE 1
(mass %, the balance being Fe and other inevitable impurity elements other than P, S and N)

| Serial number | C | Si | Mn | P | S | Al | Cu | Ni | Cr | Ti | N | Ca | Mo | Cr/Al | Cr +Al | Ca/S |
|---|---|---|---|---|---|---|---|---|---|---|---|---|---|---|---|---|
| Embodiment 1 | 0.035 | 0.045 | 1.1 | 0.0081 | 0.0032 | 1.52 | 0.2 | 0.148 | 5.4 | 0.012 | 0.0035 | 0.0022 | 0.35 | 3.56 | 6.92 | 0.69 |
| Embodiment 2 | 0.032 | 0.058 | 0.82 | 0.00808 | 0.0021 | 3.18 | 0.12 | 0.052 | 3.8 | 0.018 | 0.004 | 0.0024 | 0.32 | 1.19 | 6.98 | 1.14 |
| Embodiment 3 | 0.041 | 0.064 | 0.94 | 0.0075 | 0.0022 | 2.72 | 0.18 | 0.134 | 2.54 | 0.019 | 0.0047 | 0.0017 | 0.21 | 0.93 | 5.26 | 0.77 |
| Embodiment 4 | 0.048 | 0.078 | 0.98 | 0.0087 | 0.0034 | 3.42 | 0.15 | 0.098 | 3.18 | 0.017 | 0.0043 | 0.0028 | 0.28 | 0.93 | 6.6 | 0.82 |
| Embodiment 5 | 0.05 | 0.052 | 1.18 | 0.0084 | 0.0029 | 2.64 | 0.16 | 0.127 | 4.16 | 0.016 | 0.0041 | 0.0019 | 0.33 | 1.58 | 6.8 | 0.66 |
| Embodiment 6 | 0.048 | 0.042 | 1.15 | 0.0084 | 0.0028 | 2.16 | 0.16 | 0.137 | 4.62 | 0.016 | 0.0041 | 0.0029 | 0.34 | 2.14 | 6.78 | 1.04 |

It can be seen from table 1, compared with the prior art, each embodiment of the present invention lies in that a Cu—Cr—Mo component system in the prior art is not adopted, and P, S, C and Si with relatively high contents are not adopted too. Provided by the present invention, the design of a Cr—Al—Mo component system is actually adopted. Due to the cooperated addition of alloy elements Cr and Al, the seawater corrosion resistance is improved. Due to the addition of Mo, pitting corrosion is inhibited, a “reverse” effect of Cr with a relatively high content in inhibiting corrosion under a seawater environment is eliminated, and therefore, the seawater corrosion resistance is further improved.

A method for manufacturing the seawater-corrosion-resistant steel in the embodiments 1-6 includes the following steps:
(1) Smelting and casting: smelting is performed on a 500 kg vacuum induction furnace according to chemical element components as shown in table 1, and casting is performed to obtain a casting blank.
(2) Reheating: the casting blank is reheated to 1200° C.-1260° C.
(3) Rough rolling: an ending temperature of step of rough rolling is controlled at 950° C.-1150° C. When the thickness of a steel plate does not exceed 12 mm, the accumulative deformation in step of rough rolling is controlled to be 80% or above. When the thickness of the steel plate exceeds 12 mm, the accumulative deformation in step of rough rolling can be controlled to be 70% or above.
(4) Finish rolling: an ending temperature of step of finish rolling is controlled to be not lower than 800° C. When the thickness of the steel plate does not exceed 12 mm, a deformation ratio in step of finish rolling is controlled to be 5 or above. When the thickness of the steel plate exceeds 12 mm, the deformation ratio in step of finish rolling is controlled to be 3.5 or above.
(5) Coiling: the finish-rolled steel plate is water-cooled to 550-650° C. for coiling.
(6) Cooling to room temperature.

Specific process parameters related to the method for manufacturing the seawater-corrosion-resistant steel in the embodiments 1-6 are listed in table 2.

TABLE 2

| | | Step (2) | Step (3) | | Step (4) | | Step (5) |
|---|---|---|---|---|---|---|---|
| | | Heating | Accumulative | Ending | Ending | | Coiling |
| | Specification | temperature | deformation | temperature of | temperature of | Deformation | temperature |
| Serial number | (mm) | (° C.) | (%) | rough rolling (° C.) | finish rolling (° C.) | ratio | (° C.) |
| Embodiment 1 | 6 | 1258 | 86.0 | 952 | 880 | 7.0 | 600 |
| Embodiment 2 | 8 | 1244 | 85.3 | 980 | 865 | 5.5 | 580 |
| Embodiment 3 | 12 | 1236 | 80.0 | 1102 | 858 | 5.0 | 580 |
| Embodiment 4 | 14 | 1203 | 83.3 | 1150 | 852 | 3.6 | 560 |
| Embodiment 5 | 18 | 1218 | 77.3 | 1109 | 848 | 3.8 | 560 |
| Embodiment 6 | 20 | 1227 | 73.3 | 986 | 830 | 4.0 | 550 |

Various properties of the seawater-corrosion-resistant steel in the embodiments 1-6 are tested, and test results are listed in table 3.

TABLE 3

| Serial | Rp0.2 | Rm | Elongation | Impact energy | |
|---|---|---|---|---|---|
| number | (MPa) | (MPa) | (%) | at 40° C. (J) | Microstructure |
| Embodiment | 546 | 674 | 23.5 | 84 | Bainite + ferrite |
| 1 | | | | | |
| Embodiment | 584 | 695 | 24.5 | 76 | Bainite + ferrite |
| 2 | | | | | |
| Embodiment | 493 | 586 | 28.5 | 102 | Bainite + ferrite |
| 3 | | | | | |
| Embodiment | 466 | 589 | 21.5 | 148 | Bainite + ferrite |
| 4 | | | | | |
| Embodiment | 473 | 610 | 21.5 | 162 | Bainite + ferrite |
| 5 | | | | | |
| Embodiment | 530 | 632 | 23.5 | 158 | Bainite + ferrite |
| 6 | | | | | |

It can be seen from table 3, the seawater-corrosion-resistant steel of each embodiment shows excellent mechanical properties, and tensile properties of a test steel are tested according to a “room-temperature tensile test method in the first part of a tensile test for a metal material” in GB/T 228.1-2010, wherein the yield strength is 450 MPa-600 MPa, and the tensile strength is 550 Mpa-700 MPa. In addition, the seawater-corrosion-resistant steel of each embodiment also shows good low-temperature toughness and elongation, wherein the elongation can reach 21.5-28.5%, and the impact energy at −40° C. is 76 J or above.

In addition, the seawater-corrosion-resistant steel in all embodiments 1˜4 are compared with comparative examples 1 and 2 in terms of seawater corrosion resistance test, wherein Q345B is adopted in the comparative example 1, and Q345C-NHY3 is adopted in the comparative example 2.

Adopted in the seawater corrosion resistance test is a fully immersible testing machine manufactured by Research Institute No. 725 of China Shipbuilding Group, and the corrosion resistance is tested under the condition of full immersion in seawater in a laboratory by reference to a JB/T7901-1999 standard. Specimens have sizes of 100×30×3 mm, the surface roughness is designed according to GB1031, and the maximum allowable value of Ra is 3.2 μm. Three parallel samples are taken. Before the test, greasy dirt on the surfaces of the specimens are removed by adopting a degreasant, the specimens are cleaned with anhydrous alcohol and are blow-dried by using a dryer, the sizes of the specimens are measured, and original weights of the specimens are weighed.

A 3.5% NaCl solution is used as a test medium. The movement speeds of the specimens in a corrosive medium are 1 m/s, and the test is performed at 30° C. for 30 d. The corrosion rate is calculated as follows:

$$Cr = \frac{87600 {Δ}_{m}}{t ρ S}$$

In the formula, Cr represents an annual average corrosion rate and has a dimension expressed by mm/a; Δₘ represents weight loss ratios of the specimens before and after the test and has a dimension expressed by g; S represents the total surface area of the specimens and has a dimension expressed by cm²; p represents the density of the specimens, and p=7.85 g/cm³; and t represents corrosion time and has a dimension expressed by h.

Corrosion rates and relative weight loss ratios of the seawater-corrosion-resistant steel in the embodiments 1-4 and the comparative examples 1 and 2 are listed in table 4. The relative weight loss ratio is obtained by calculating a relative ratio of a corrosion rate (Cr, mm/a) obtained by calculating the corrosion weight loss of each specimen to a corrosion rate in the comparative example 1.

TABLE 4

| | Corrosion rate | Relative weight |
|---|---|---|
| Serial number | (mm/a) | loss ratio (%) |
| Comparative | 0.187 | 100 |
| example 1 | | |
| Comparative | 0.135 | 72.4 |
| example 2 | | |
| Embodiment 1 | 0.068 | 36.63 |
| Embodiment 2 | 0.07 | 37.64 |
| Embodiment 3 | 0.068 | 36.34 |
| Embodiment 4 | 0.071 | 38.22 |
| Embodiment 5 | 0.070 | 37.41 |
| Embodiment 6 | 0.069 | 36.79 |

It can be seen from table 4, each embodiment of the present invention shows higher seawater corrosion resistance than comparative examples 1-2, and the annual average corrosion thickness is lower than 0.1 mm/a.

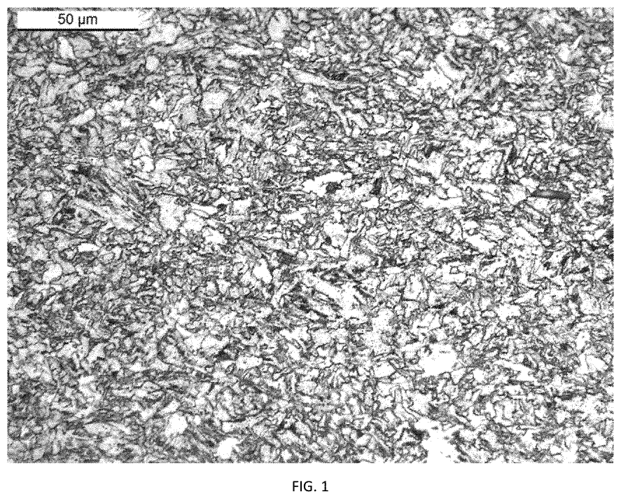

FIG. 1 shows a microstructure of a seawater-corrosion-resistant steel in an embodiment 1. As shown in FIG. 1, the seawater-corrosion-resistant steel in the embodiment 1 has a microstructure of bainite and ferrite.

Compared with the prior art, the seawater-corrosion-resistant steel and the manufacturing method therefor provided by the present invention have the following advantages and beneficial effects: the seawater-corrosion-resistant steel provided by the present invention not only has good seawater corrosion resistance, but also has high strength and excellent toughness and welding property so as to be very suitable for a marine steel structure.

In addition, the seawater-corrosion-resistant steel provided by the present invention adopts the design of a Cr—Al—Mo component system. Due to the cooperated addition of the alloy elements Cr and Al, the seawater corrosion resistance is improved. Due to the addition of Mo, pitting corrosion is inhibited, a “reverse” effect of Cr with a relatively high content in inhibiting corrosion under a seawater environment is eliminated, and therefore, the seawater corrosion resistance is further improved.

In addition, the seawater-corrosion-resistant steel provided by the present invention is good in forming property, capable of meeting the subsequent cold machining requirement of the steel plate, easy to weld and capable of meeting the requirement on welding without preheating at a temperature higher than 0° C.

The manufacturing method provided by the present invention also has the above-mentioned advantages and beneficial effects. In addition, a controlled rolling and cooling production process is adopted in the manufacturing method provided by the present invention. In this way, heat treatment is not needed after rolling, and the steel can be supplied directly in a hot rolling state, thereby effectively shortening the supply period and reducing the production cost.

It should be noted that the prior art within the protective scope of the present invention is not limited to the embodiments given in the present application, and all of the prior art not contradicting the solutions of the present invention, including, but not limited to previous patent documents, previous public publications, previous public applications and the like should fall within the protective scope of the present invention.

In addition, combination modes of all technical features in the present invention are not limited to combination modes recorded in claims of the present invention or combination modes recorded in the specific embodiments, and all the technical features recorded in the present invention can be freely combined for incorporated in any mode, unless mutual contradiction occurs.

It should be further noted that the embodiments illustrated as above are merely specific embodiments of the present invention. Obviously, the present invention is not limited to the above embodiments, and similar changes or transformations thereof can be directly obtained or easily envisioned by those skilled in the art according to the contents disclosed by the present invention, and shall fall within the protective scope of the present invention.

1. Seawater-corrosion-resistant steel, characterized in chemical elements by mass as follows:
0.03-0.05% of C, 0.04-0.08% of Si, 0.8-1.2% of Mn, 0.1-0.2% of Cu, 2.5-5.5% of Cr, 0.05-0.15% of Ni, 0.15-0.35% of Mo, 1.5-3.5% of Al, 0.01-0.02% of Ti, 0.0015-0.003% of Ca, and the balance being Fe and other inevitable impurities.

2. The seawater-corrosion-resistant steel according to claim 1, wherein the mass percentage of elements Cr and Al further satisfies the following: the ratio of Cr/Al is 0.8-4, and Cr+Al≤7.0%.

3. The seawater-corrosion-resistant steel according to claim 1, wherein the mass percentage of Cr is 3.0-4.5%, and/or the mass percentage of Al is 1.5-2.2%.

4. The seawater-corrosion-resistant steel according to claim 1, wherein, as said other inevitable impurities, elements P, S and N satisfy at least one of mass percentages as follows: P≤0.015%, S≤0.004%, and N≤0.005%.

5. The seawater-corrosion-resistant steel according to claim 4, wherein mass percentages of Ca and S further satisfies Ca/S≥0.65.

6. The seawater-corrosion-resistant steel according to claim 1, characterized by microstructure of bainite and ferrite.

7. The seawater-corrosion-resistant steel according to claim 1, wherein said steel has a yield strength of 450 MPa or above, tensile strength of 550 MPa or above, and an annual average corrosion rate of no more than 0.1 mm/a when fully immersed in seawater.

8. A method for manufacturing the seawater-corrosion-resistant steel of claim 1, comprising the steps of:
(1) smelting and casting;
(2) reheating, wherein a casting blank is reheated to 1200° C.-1260° C.;
(3) rough rolling;
(4) finish rolling;
(5) coiling; and
(6) cooling to room temperature.

9. The manufacturing method according to claim 8, wherein, in step (3), an ending temperature of step of rough rolling is controlled within a range of 950° C.-1150° C.; when the thickness of a steel plate does not exceed 12 mm, the accumulative deformation in step of rough rolling is controlled to be 80% or above; and when the thickness of the steel plate exceeds 12 mm, the accumulative deformation in step of rough rolling is controlled to be 70% or above.

10. The manufacturing method according to claim 8, wherein, in step (4), an ending temperature of step of finish rolling is controlled to be not lower than 800° C.; when the thickness of a steel plate does not exceed 12 mm, a deformation ratio in step of finish rolling is controlled to be 5 or above; and when the thickness of the steel plate exceeds 12 mm, the deformation ratio in step of finish rolling is controlled to be 3.5 or above.

11. The manufacturing method according to claim 8, wherein, in step (5), the finish-rolled steel plate is water-cooled to 550-650° C. for coiling.

12. The seawater-corrosion-resistant steel of claim 2, wherein said steel has a yield strength of 450 MPa or above, tensile strength of 550 MPa or above, and an annual average corrosion rate of no more than 0.1 mm/a when fully immersed in seawater.

13. The seawater-corrosion-resistant steel of claim 3, wherein said steel has a yield strength of 450 MPa or above, tensile strength of 550 MPa or above, and an annual average corrosion rate of no more than 0.1 mm/a when fully immersed in seawater.

14. The seawater-corrosion-resistant steel of claim 4, wherein said steel has a yield strength of 450 MPa or above, tensile strength of 550 MPa or above, and an annual average corrosion rate of no more than 0.1 mm/a when fully immersed in seawater.

15. The seawater-corrosion-resistant steel of claim 5, wherein the steel has a yield strength of 450 MPa or above, tensile strength of 550 MPa or above, and an annual average corrosion rate of no more than 0.1 mm/a when fully immersed in seawater.

16. The seawater-corrosion-resistant steel of claim 6, wherein the steel has a yield strength of 450 MPa or above, tensile strength of 550 MPa or above, and an annual average corrosion rate of no more than 0.1 mm/a when fully immersed in seawater.
